(19) United States
(12) Patent Application Publication
(10) Pub. No.: US 2011/0093757 A1
(43) Pub. Date: Apr. 21, 2011

(54) METHOD AND APPARATUS FOR HANDLING ERRORS IN A SYNCHRONOUS UL HARQ PROCESS

(75) Inventors: Ji Yun SEOL, Seongnam-si (KR); Jonghyun WON, Seongnam-si (KR); Hyunkyu YU, Seoul (KR); Mihyun LEE, Seongnam-si (KR)

(73) Assignee: SAMSUNG ELECTRONICS CO. LTD., Suwon-si (KR)

(21) Appl. No.: 12/627,439

(22) Filed: Nov. 30, 2009

Related U.S. Application Data
(60) Provisional application No. 61/252,493, filed on Oct. 16, 2009.

(51) Int. Cl. H04L 1/18; G06F 11/14

(52) U.S. Cl. 714/749; 714/750; 714/748; 714/E11.113

(57) ABSTRACT

An apparatus and method for handling an error that may occur during a HARQ process are provided. The method includes determining that an UpLink (UL) HARQ burst has been transmitted on a first resource, determining if the UL HARQ burst has been received, determining if the first resource for UL HARQ burst transmission needs to be changed, and transmitting feedback information regarding receipt of the UL HARQ burst and whether the first resource needs to be changed.

### CROSS REFERENCE TO RELATED APPLICATIONS

This application claims the benefit under 35 U.S.C. §119(e) of U.S. Provisional Application No. 61/252,493, filed Oct. 16, 2009.

### BACKGROUND OF THE INVENTION

1. Field of the Invention

The present invention relates to an apparatus and method for improving a Hybrid Automatic Retransmission reQuest (HARQ) process. More specifically, the present invention relates to an apparatus and method for handling an error that may occur during a HARQ process.

2. Description of the Related Art

A Hybrid Automatic Retransmission reQuest (HARQ) process is used to improve performance of a mobile communication system by correcting errors made during transmission of data. In an HARQ process, error correction information is added to transmitted data and used to ensure the transmitted data is received correctly. If it is determined that the data is not received correctly, the data is transmitted again in a retransmission burst. In a conventional HARQ process, information regarding the timing of a retransmission burst is provided in a DownLink (DL) Media Access Protocol (MAP) using an asynchronous procedure. For example, a Base Station (BS) provides a DL MAP including retransmission burst information for each transmission in an asynchronous manner.

In an UpLink (UL) HARQ procedure, a synchronous HARQ process, which reduces system overhead and supports short latency, is applied in most of the recent communication technologies. In the synchronous UL HARQ procedure, if an apparatus that transmits UL data needs to send a retransmission burst, it will transmit the initial retransmission and any subsequent retransmission using the same UL resource allocated through a UL-MAP according to a predefined cycle unless the UL resource allocation for retransmission is changed by another UL-MAP, thus maintaining a regular retransmission delay. Accordingly, the synchronous UL HARQ procedure has a given correspondence relation between initial transmission timing and retransmission timing. This correspondence is referred to as UL HARQ interlace.

The UL HARQ interlace indicates that a relation between a time slot in which resource allocation information (that is, a MAP) indicating resources allocated to data transmission and a time slot in which data is transmitted according to the MAP, a relation between a time slot in which the data is transmitted and a time slot in which a feedback corresponding to the data is transmitted, and a relation between a time slot in which the feedback is transmitted and a time slot in which data corresponding to the feedback is transmitted or retransmitted, are prescribed regularly.

An adaptive UL HARQ procedure may be used to further improve performance of the communication system. In an adaptive HARQ process, information regarding UL resource allocation for UL HARQ transmission may be changed depending on system conditions. The changed information is provided to the UL transmitting apparatus through a UL Advanced-MAP (A-MAP). In that case, the UL transmitting apparatus receives and decodes the UL A-MAP and modifies the UL HARQ process according to information contained therein. For example, resource allocation information contained in a UL A-MAP may indicate that the location of UL retransmission burst within a transmission frame should be changed or retransmission itself should be stopped due to insufficient resources or potential collision when scheduling.

Table 1 represents an HARQ Feedback (HF)-A-MAP Information Element (IE) used by a Base Station (BS) to inform a Mobile Station (MS) of the success or failure of receipt of a UL HARQ burst. More specifically, the BS will use the HF-A-MAP IE to ACKnowledge (ACK) or Negative ACKnowledge (NACK) successful receipt of the UL HARQ burst. As illustrated in Table 1, the HF-A-MAP IE value comprises a single bit.

TABLE 1
HF-A-MAP IE

| | | Assigned Value and Associated |
|---|---|---|
| Indicator | Bits | Information |
| HF-A-MAP IE | 1 | 0b0: ACK feedback info. |
| | | 0b1: NACK feedback info. |

FIG. 1(a) illustrates a conventional operation of a synchronous UL HARQ process when there is no change of resource allocation information.

Referring to FIG. 1(a), in step 101, an MS is made aware of synchronous UL HARQ resource information by means of a UL A-MAP transmitted from a BS. The UL A-MAP may contain information regarding a time slot for initial HARQ retransmission, a time slot in which feedback is transmitted, a time slot in which data corresponding to the feedback is retransmitted, and the like. In step 103, the MS transmits an initial UL HARQ burst in a time slot based on information received in step 101. In step 105, the BS transmits a NACK message using an HF-A-MAP IE indicating that the initial UL HARQ burst of step 103 was not received successfully. Notably, at the time the NACK is transmitted by the BS, there is no UL A-MAP indicating that the resources for synchronous UL HARQ have been changed. Accordingly, the MS retransmits a UL HARQ burst in step 107 using the same resources identified in step 101. Because the BS again does not receive the UL HARQ burst of step 107, the BS transmits in step 109 a NACK using an HF-A-MAP IE. Similar to the transmission of step 105, the transmission of step 109 does not contain a UL A-MAP indicating a change of resources. Accordingly, in step 111, the MS retransmits a UL HARQ burst using the resources identified in step 101. Finally, the BS transmits an ACK using an HF-A-MAP IE in step 113 indicating successful receipt of the UL HARQ burst.

FIGS. 1(b) and 1(c) illustrate conventional operations of a UL synchronous HARQ process when there is a change of resource allocation information.

Referring to FIG. 1(b), in step 121, the BS transmits a UL A-MAP that includes resource information to be used by the MS in a HARQ process. In step 123, the MS transmits an initial UL HARQ burst to the BS. Because the BS does not properly receive the initial UL HARQ burst transmitted in step 123, the BS transmits to the MS an HF-A-MAP IE corresponding to NACK in step 125. However, in step 125 the BS also transmits a UL A-MAP which contains information regarding a change of resources to be used in the UL HARQ procedure. Accordingly, in step 127, the MS retransmits a UL HARQ burst using the newly allocated resources indicated by the UL A-MAP received in step 125. After successful receipt of the UL HARQ burst transmitted in step 127, the BS transmits an ACK recognition in step 129.

Referring to FIG. 1(c), in step 131, the BS transmits a UL A-MAP that includes resource information to be used by the MS in a HARQ process. In step 133, the MS transmits an initial UL HARQ burst to the BS. Because the BS does not properly receive the initial UL HARQ burst transmitted in step 133, the BS transmits an HF-A-MAP IE corresponding to NACK to the MS in step 135. Also transmitted in step 135 is a UL A-MAP indicating a change in resources available for the UL HARQ procedure. In this case, the changed resources require that the transmission of a UL HARQ burst be skipped in the current frame. Because the MS successfully receives and decodes the UL A-MAP in step 135, the MS skips retransmission of the UL HARQ burst in the frame relevant to the UL A-MAP including the skip instruction. This is indicated in FIG. 1(c) by the dashed lines and text indicating that no UL HARQ burst is transmitted in the relevant frame. In step 137, the BS again transmits an HF-A-MAP IE corresponding to NACK based on improper receipt or decoding of the UL HARQ burst of step 133. In step 139, the MS resumes transmission of the UL HARQ burst after skipping retransmission for one frame as directed by the BS. Finally, upon proper receipt and decoding of the UL HARQ burst, the BS transmits an HF-A-MAP IE corresponding to ACK in step 141.

In the above conventional procedures, if a UL A-MAP is normally received by the MS, there is no problem caused by a change of resource allocation for the UL synchronous HARQ procedure. However, an MS may fail to detect or decode a UL A-MAP that contains resource allocation information for UL synchronous HARQ. In that case, the MS is not aware that the resource allocation for synchronous UL HARQ has changed and some problems may occur between the MS and the BS.

FIGS. 2(a) and 2(b) illustrate conventional operations when an MS fails to receive information regarding a change of resource allocation information for a synchronous UL HARQ procedure.

Referring to FIG. 2(a), in step 201, an MS is made aware of synchronous UL HARQ resource information by means of a UL A-MAP transmitted from the BS. In step 203, the MS transmits an initial UL HARQ burst in a time slot or other resource based on information received in step 201. In step 205, the BS transmits an HF-A-MAP IE corresponding to NACK indicating that the initial UL HARQ burst of step 203 was not received. Notably, in the same subframe in which the NACK is transmitted by the BS, the BS also transmits a UL A-MAP indicating that the resources used for synchronous UL HARQ have been changed. However, the UL A-MAP is either not received by the MS or is not properly decoded. Accordingly, in step 207 the MS retransmits the UL HARQ burst using the original resources indicated by the BS in step 201, rather than the updated resources indicated by the UL A-MAP in step 205. In this case, the UL HARQ burst transmitted in step 207 may cause interference with other signals concurrently received by the BS. Finally, in step 209, the BS again transmits an HF-A-MAP IE corresponding to NACK to the MS indicating that the UL HARQ burst was not properly received.

Referring to FIG. 2(b), in step 221, an MS is made aware of synchronous UL HARQ resource information by means of a UL A-MAP transmitted from the BS. In step 223, the MS transmits an initial UL HARQ burst in a time slot or other resource based on information received in step 221. In step 225, the BS transmits an HF-A-MAP IE corresponding to NACK indicating that the initial UL HARQ burst of step 223 was not received. The BS also transmits a UL A-MAP in step 225. The UL A-MAP transmitted in step 225 contains information indicating that the UL HARQ burst is to be skipped in the next transmission frame. However, the UL A-MAP is not received or is not properly decoded by the MS so that the MS retransmits a UL HARQ burst in step 227 in accordance with the synchronous HARQ process. The UL HARQ burst transmitted in step 227 may cause interference at the BS. Finally, in step 229, the BS again transmits an HF-A-MAP IE corresponding to NACK to the MS indicating that the UL HARQ burst was not properly received.

When detection and/or decoding of a UL A-MAP fails, UL synchronous HARQ retransmission is performed by the MS using the resources allocated for initial transmission or the resource allocation changed for the previous retransmission because the MS does not know that the allocated resources have been changed. In such a situation, error recovery is not possible and there is an increased problem as retransmission is repeatedly performed using the resource allocated for last transmission prior to max HARQ retransmission. In this case, the UL HARQ retransmission by the MS may cause interference at the BS and deteriorate the uplink performance of the entire cell.

Therefore, a need exists for an improved apparatus and method for handling errors in a synchronous UL HARQ process.

### SUMMARY OF THE INVENTION

An aspect of the present invention is to address at least the above-mentioned problems and/or disadvantages and to provide at least the advantages described below. Accordingly, an aspect of the present invention is to provide an improved apparatus and method for handling errors in a synchronous Hybrid Automatic Retransmission reQuest (HARQ) process.

Another aspect of the present invention is to provide a new field to indicate one of ACKnowledge (ACK), Negative ACKnowledge (NACK), NACK with skip retransmission indication, and NACK with resource allocation information indication.

Yet another aspect of the present invention is to provide an improved error handling method when a resource allocation for retransmission has changed. In an exemplary implementation, the retransmission includes a method of synchronous UpLink (UL) HARQ which is used in the Institute of Electrical and Electronics Engineers (IEEE) 802.16m standard.

Still another aspect of the present invention is to provide a new indication of skipping for UL synchronous HARQ.

According to an aspect of the present invention, a method in a Base Station (BS) for feeding back HARQ information is provided. The method includes determining that a UL HARQ burst has been transmitted on a first resource, determining if the UL HARQ burst has been received, determining if the first resource for UL HARQ burst transmission needs to be changed, and transmitting feedback information regarding receipt of the UL HARQ burst and whether the first resource needs to be changed.

According to another aspect of the present invention, an apparatus in a BS for feeding back HARQ information is provided. The apparatus includes a controller for determining that a UL HARQ burst has been transmitted on a first resource, for determining if the UL HARQ burst has been received, and for determining if the first resource for UL HARQ burst transmission needs to be changed, and a transceiver for receiving the UL HARQ burst and for transmitting feedback information regarding receipt of the UL HARQ burst and whether the first resource needs to be changed.

According to still another aspect of the present invention, a method in a Mobile Station (MS) for receiving HARQ feedback information is provided. The method includes determining that feedback information has been transmitted, determining if the feedback information has been received, if the feedback information has been received, determining if a previously transmitted UL HARQ burst was received by a receiving apparatus based on the feedback information, and, if the previously transmitted UL HARQ burst was not received by the receiving apparatus, determining if a resource for transmission of the UL HARQ burst has changed based on the feedback information.

According to another exemplary aspect of the present invention, an apparatus in an MS for receiving HARQ feedback information is provided. The apparatus includes a transceiver for receiving feedback information, and a controller for determining that feedback information has been transmitted, for determining if the feedback information has been received, for, if the feedback information has been received, determining if a previously transmitted UpLink (UL) HARQ burst was received by a receiving apparatus based on the feedback information, and for, if the previously transmitted UL HARQ burst was not received by the receiving apparatus, determining if a resource for transmission of the UL HARQ burst has changed based on the feedback information.

Other aspects, advantages, and salient features of the invention will become apparent to those skilled in the art from the following detailed description, which, taken in conjunction with the annexed drawings, discloses exemplary embodiments of the invention

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1(a) illustrates a conventional operation of a synchronous UpLink (UL) Hybrid Automatic Retransmission reQuest (HARQ) process when there is no change of resource allocation information;

FIGS. 1(b) and 1(c) illustrate conventional operations of a UL synchronous HARQ process when there is a change of resource allocation information;

FIGS. 2(a) and 2(b) illustrate conventional operations when a Mobile Station (MS) fails to receive information regarding a change of resource allocation information for a synchronous UL HARQ procedure;

FIGS. 3(a) and 3(b) illustrate operations of a synchronous UL HARQ process using additional feedback information according to an exemplary embodiment of the present invention;

FIG. 4 illustrates a method in a Base Station (BS) for feeding back HARQ information according to an exemplary embodiment of the present invention; and

FIG. 5 illustrates a method in an MS for receiving HARQ feedback information according to an exemplary embodiment of the present invention;

FIG. 6 is a diagram illustrating an internal structure of a BS apparatus according to an exemplary embodiment of the present invention; and

FIG. 7 is a diagram illustrating an internal structure of an MS apparatus according to an exemplary embodiment of the present invention.

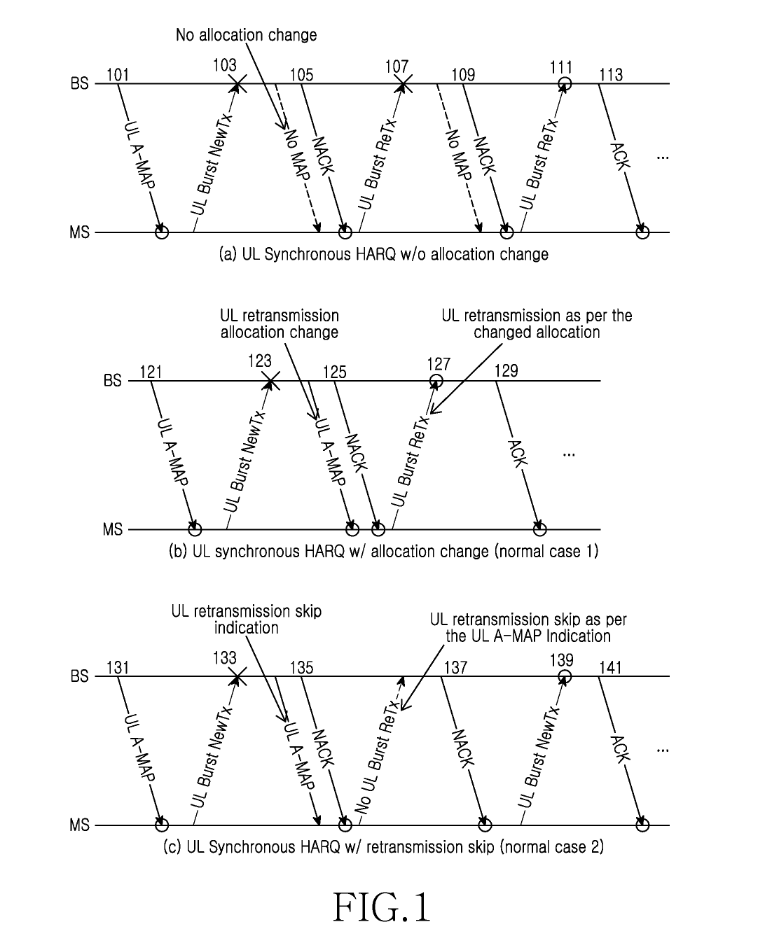

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an improved apparatus and method for transmitting feedback information to a Mobile Station (MS) regarding a synchronous Hybrid Automatic Repeat reQuest (HARQ) procedure. More specifically, exemplary embodiments of the present invention include additional feedback information provided by an HARQ Feedback-Advanced-Media Access Protocol Information Element (HF-A-MAP IE).

In the following description, reference may be made to terminology specific to the Institute of Electrical and Electronics Engineers (IEEE) 802.16m standard. However, this is merely for convenience of description and not to be considered a limitation in application of the present invention. That is, the inventive concepts as described in this specification and defined by the appended claims and their equivalents are applicable to any communication technology including WiMAX/WiBro technology, Long Term Evolution (LTE), LTE-Advanced (LTE-A) technology, any of the Third Generation Partnership Project (3GPP) and 3GPP2 technologies, and the like.

In an exemplary embodiment of the present invention, additional information is fed back to an MS by a Base Station (BS) as part of a HARQ procedure. More specifically, during a synchronous UpLink (UL) HARQ procedure, additional feedback information is provided by a BS to an MS to avoid the potential for signal interference in the event resources for the synchronous UL HARQ procedure have changed. The additional information may be indicated by the use of a single bit of feedback data provided to the MS.

Table 2 represents an HF-A-MAP IE according to an exemplary embodiment of the present invention. As illustrated in Table 2, four possible states of information as determined by different combinations of 2 bits of information may be fed back to an MS.

TABLE 2
HF-A-MAP IE

| Indicator | Bits | Assigned Value and Associated Information |
|---|---|---|
| HF-A-MAP IE | 2 | 0b00: ACK feedback information |
| | | 0b01: NACK feedback information |
| | | 0b10: NACK with retransmission skip indication |
| | | 0b11: NACK with associated UL A-MAP |
| | | existence indication |

As indicated in Table 2, the HF-A-MAP IE may indicate either an ACK or NACK of the UL HARQ burst transmitted by the MS, and may additionally provide, in the event an HF-A-MAP IE corresponding to NACK is fed back, an indication that retransmission of a UL HARQ burst is to be skipped in the relevant frame as per the synchronous HARQ process, or an indication that resources for the synchronous UL HARQ process have been changed. An exemplary process using the HF-A-MAP IE of Table 2 will be described in more detail below. However, four different scenarios addressed by the HF-A-MAP IE of Table 2 will first be described in more detail from the perspective of both the MS and the BS.

First, from the perspective of the BS, if a UL HARQ burst is successfully received, the BS sets a value of the HF-A-MAP IE corresponding to ACK (e.g., 0b00 in Table 2) and transmits the IE to the MS. When the IE corresponding to ACK for the UL HARQ is normally received at the MS, the MS considers that the UL HARQ burst was successfully received and stops HARQ retransmission.

Second, if the UL HARQ burst is not successfully received by the BS, the BS sets a value of the HF-A-MAP IE corresponding to NACK. At this time, the BS also determines if a change of retransmission resources is necessary. When a change of retransmission resources is not necessary, a value of the HF-A-MAP IE is set corresponding to only NACK (e.g., 0b01 in Table 2) and is transmitted to the MS. If HF-A-MAP IE corresponding to NACK for UL synchronous HARQ is received by the MS, the UL HARQ retransmission is performed using the previously allocated resource information according to normal operation of synchronous UL HARQ.

In a third scenario, the BS may determine that a change of retransmission resources is necessary and therefore that separate UL resource allocation information is to be transmitted to the MS (e.g., a separate UL A-MAP). In this case, the HF-A-MAP IE is set to a value corresponding to NACK with UL resource allocation information indication (e.g., 0b11 in Table 2) to inform the MS of the existence of the UL resource allocation information. When the HF-A-MAP IE corresponding to NACK with UL resource allocation information indication for synchronous UL HARQ is received by the MS, retransmission for synchronous UL HARQ is performed by the MS. However, the MS recognizes that a change of resource allocation for the retransmission has occurred. Thus, the MS determines if related UL resource allocation information has been received and performs retransmission using the resource allocation made with the separate UL A-MAP, wherein the allocated resources for retransmission may have changed. In this situation, if the MS determines that the related UL resource allocation information has not been received, transmission of the synchronous UL HARQ is stopped to avoid potential interference at the BS.

In a fourth scenario, the BS determines that the MS should skip retransmission of the UL HARQ burst. In this case, the HF-A-MAP IE is set to a value corresponding to either NACK with UL resource allocation information indication (e.g., 0b11 in Table 2) or NACK with retransmission skip indication (e.g., 0b10 in Table 2) and is transmitted to the MS. That is, to inform the MS of the retransmission skip, the BS may transmit a UL A-MAP containing information that retransmission of the UL HARQ burst is to be skipped. In this case, the BS transmits an HF-A-MAP IE corresponding to NACK with UL A-MAP (e.g., 0b11 in Table 2). As in the third scenario, when the NACK with UL resource allocation information indication is received by the MS, the MS determines if the UL resource allocation information is received and performs retransmission according to the received information. If the MS fails to receive the related UL resource allocation information, transmission of UL synchronous HARQ is stopped to avoid potential interference at the BS.

In an alternative exemplary implementation of the fourth scenario, the BS only transmits an HF-A-MAP IE corresponding to NACK with skip indication (e.g., 0b10 in Table 2). In this case, the MS skips retransmission of the UL HARQ burst by virtue of receipt of the HF-A-MAP IE alone. Accordingly, overhead is reduced because the separate UL A-MAP need not be transmitted by the BS.

In any of the above scenarios, if the MS fails to receive the proposed field of the HF-A-MAP IE, for example, due to a detection failure based on a signal strength less than a threshold, the operation of UL synchronous HARQ is stopped to prevent the MS from potentially causing interference with the BS due to a changed retransmission resource allocation or due to the successful receipt of the UL HARQ burst at the BS resulting in the termination of the current HARQ retransmission process. However, even if the MS fails to receive the proposed field of the HF-A-MAP IE, if UL resource allocation information related to corresponding synchronous UL HARQ is successfully received, for example by checking at least one of HARQ Channel Identifier (ACID), HARQ Identifier Sequence Number (AI_SN) and Station Identifier (STID) of UL A-MAP to determine if the UL A-MAP corresponds to the MS and includes information of the allocated resource for the retransmission of the HARQ burst under synchronous UL HARQ process, operation of the synchronous UL HARQ procedure according to the corresponding UL A-MAP continues.

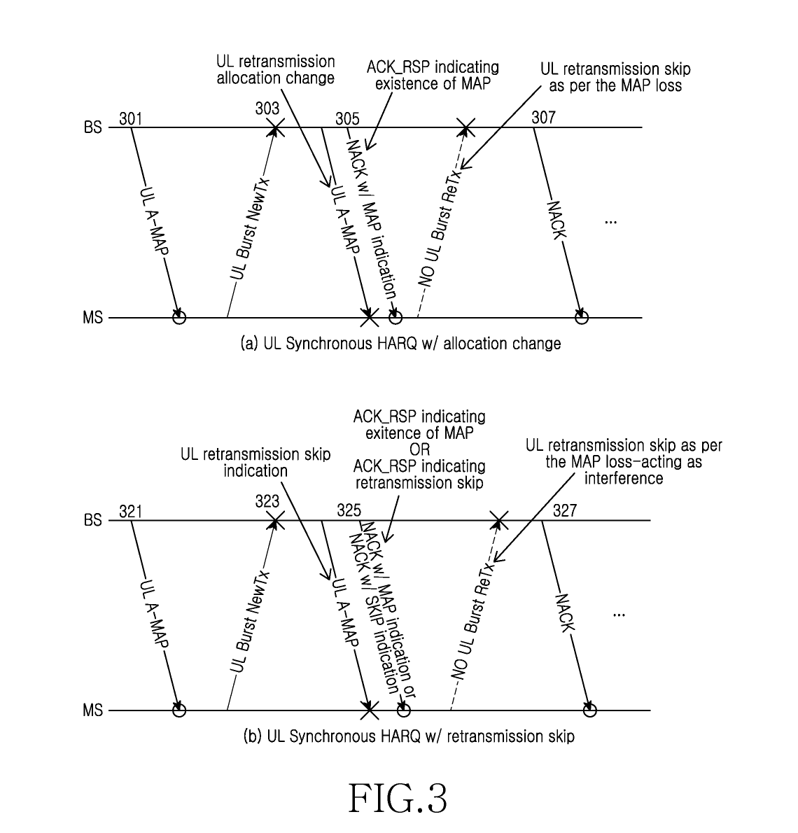

FIGS. 3(a) and 3(b) illustrate operations of a synchronous UL HARQ process using additional feedback information according to an exemplary embodiment of the present invention.

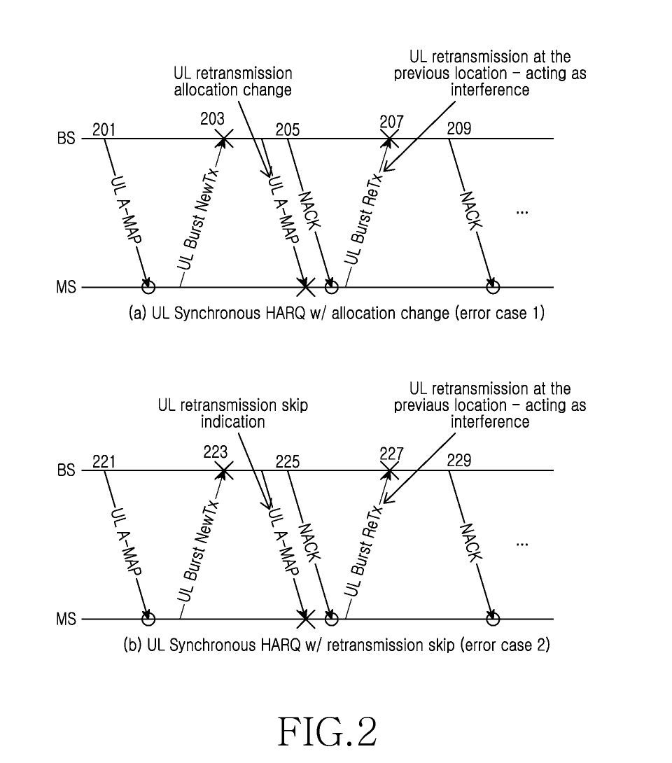

Referring to FIG. 3(a), in step 301, an MS is made aware of synchronous UL HARQ resource information by means of a UL A-MAP transmitted from the BS. The UL A-MAP may contain information regarding a time slot for initial HARQ transmission, a time slot in which feedback is transmitted, a time slot in which data corresponding to the feedback is retransmitted, and the like. In step 303, the MS transmits an initial UL HARQ burst in a time slot based on information received in step 301. However, the initial UL HARQ burst transmitted in step 303 is not properly received and/or is not properly decoded by the BS. Furthermore, the BS has determined that resources for the synchronous UL HARQ procedure must be changed. In this situation, the BS must transmit an HF-A-MAP IE corresponding to NACK to the MS indicating that the UL HARQ burst was not properly received and must also transmit a UL A-MAP indicating that the resources for the synchronous UL HARQ procedure have changed. In the conventional art of FIG. 2(a) for example, the BS would transmit the UL A-MAP including information regarding the changed UL HARQ resources, and would transmit a single bit of information in the HF-A-MAP IE corresponding to NACK in response to the failed receipt of the UL HARQ burst. However, according to an exemplary embodiment of the present invention, the BS transmits the UL A-MAP regarding the change of resources, and transmits an HF-A-MAP IE including two bits of information indicating not only that the burst was not properly received (i.e., NACK), but also indicating that resources for the synchronous UL HARQ process have changed. Accordingly, because the MS is now aware that the UL HARQ resources have been changed, it will determine if additional information regarding the changed resources has been received before retransmitting the UL HARQ burst.

More specifically, in step 305 the BS transmits a UL A-MAP including information regarding changed resources for the synchronous UL HARQ process and transmits a 2-bit HF-A-MAP IE corresponding to NACK with UL resource allocation information indication which indicates not only that the initial burst was not received, but also that the BS has changed resources for the UL HARQ process. Accordingly, upon receipt of the HF-A-MAP IE from the BS, the MS will ensure that it has received the UL A-MAP from the BS prior to retransmission of the UL HARQ burst. In the example of FIG. 3(a), the MS receives the 2-bit HF-A-MAP IE but does not properly receive and/or decode the UL A-MAP. Accordingly, because the MS is aware that resources for UL HARQ have changed but has not received information regarding the new resources, the MS does not retransmit the UL HARQ burst despite receipt of NACK. In this manner, interference at the BS can be avoided. Finally, the BS again transmits a NACK in step 307.

Referring to FIG. 3(b), in step 321, an MS is made aware of synchronous UL HARQ resource information by means of a UL A-MAP transmitted from the BS, and in step 323 the MS transmits an initial UL HARQ burst in a time slot based on information received in step 321, However, the UL HARQ burst is not properly received and/or is not properly decoded by the BS. The process of steps 321 and 323 are substantially the same as steps 301 and 303 of FIG. 3(a), thus further explanation will be omitted for convenience. In the exemplary embodiment of FIG. 3(b), the BS has determined that retransmission of a UL HARQ burst is to be skipped during the next transmission frame. In this situation, the BS may transmit either an HF-A-MAP IE corresponding to NACK with UL resource allocation information indication or an HF-A-MAP IE corresponding to NACK with retransmission skip indication. If the BS transmits the HF-A-MAP IE corresponding to NACK with UL resource allocation information indication, the BS also transmits a UL A-MAP containing the information regarding the retransmission skip. Alternatively, if the BS transmits the HF-A-MAP IE corresponding to NACK with retransmission skip indication, the BS need not transmit a UL A-MAP as the MS is made aware that retransmission is to be skipped by receipt of the HF-A-MAP IE alone. In this case, overhead of signaling the information at the BS may be reduced.

If the BS transmits the HF-A-MAP IE corresponding to NACK with UL resource allocation information indication, the MS is made aware that resources have changed for the UL HARQ procedure and thus will determine if the resource information is received through a UL A-MAP transmitted by the BS in the same subframe. In the illustrated example of FIG. 3(b), the UL A-MAP is not properly received and/or is not properly decoded. Accordingly, because the MS is aware that resources for UL HARQ retransmission have changed but has not received information regarding the changes themselves, the MS stops retransmission of the UL HARQ burst. Finally, the BS again transmits a NACK in step 327.

Alternatively, if the BS transmits the HF-A-MAP IE corresponding to NACK with retransmission skip indication, the MS is made aware that UL HARQ burst retransmission is to be skipped in the current subframe. Accordingly, the MS skips retransmission. Finally, the BS again transmits a NACK in step 327.

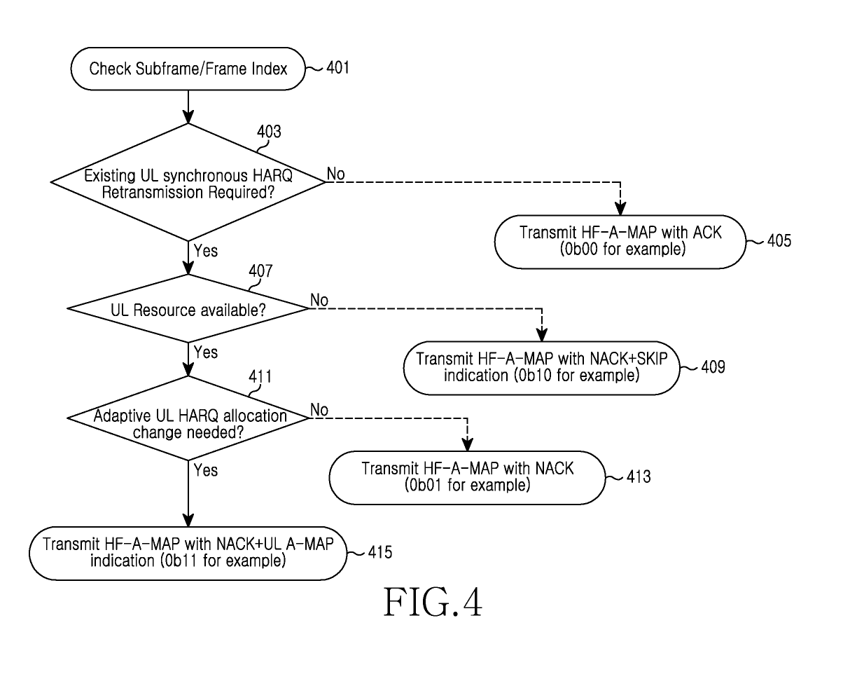

FIG. 4 illustrates a method in a BS for feeding back HARQ information according to an exemplary embodiment of the present invention.

Referring to FIG. 4, in step 401, the BS checks the subframe index and the frame index to determine the relevant frame/subframe to transmit proper information/feedback to a corresponding MS under UL HARQ procedure and evaluates the information that needs to be contained therein. In step 403, the BS determines if a synchronous UL HARQ burst from the MS is properly received. More specifically, the BS determines if burst retransmission is required in an existing UL HARQ procedure. If the BS determines that the UL HARQ burst is successfully received from the MS, in other words that the UL HARQ burst need not be retransmitted, the BS sets a value of an HF-A-MAP IE corresponding to ACK (e.g., 0b00 in Table 2) and transmits the HF-A-MAP IE to the MS in step 405. On the other hand, if it is determined in step 403 that the UL HARQ burst is not successfully received, the BS determines in step 407 if a UL resource is available for retransmission of the UL HARQ burst by the MS. If it is determined in step 407 that a UL resource is not available for UL HARQ burst retransmission, the BS sets a value of an HF-A-MAP IE corresponding to NACK with retransmission skip indication (e.g., 0b10 in Table 2) and transmits the HF-A-MAP IE to the MS in step 409. As discussed above, by transmitting the HF-A-MAP IE corresponding to NACK with retransmission skip indication in step 409, the MS may be made aware that retransmission of a UL HARQ burst is to be skipped in the relevant retransmission frame as per the synchronous HARQ process without the need to also transmit a UL A-MAP, thus reducing overhead. As an alternative, the BS may decide to transmit an HF-A-MAP IE corresponding to NACK with associated UL-A-MAP existence indication (e.g., 0b11 in Table 2), where the UL A-MAP includes an instruction for the MS to skip the retransmission at the relevant retransmission frame.

If the BS determines in step 407 that a UL resource is available for UL HARQ burst retransmission, in step 411 the BS determines if the resource used for the UL HARQ retransmission should be changed from the resource on which the UL HARQ burst was previously sent. If it is determined by the BS that the resource for retransmission of the UL HARQ burst should not be changed from the resource on which the UL HARQ burst was previously sent, the BS sets a value of an HF-A-MAP IE corresponding to NACK (e.g., 0b01 in Table 2) and transmits the HF-A-MAP IE to the MS in step 413. On the other hand, if it is determined by the BS that the resource for retransmission of the UL HARQ burst should be changed from the resource on which the UL HARQ burst was previously sent, the BS sets a value of an HF-A-MAP IE corresponding to NACK with UL A-MAP information indication (e.g., 0b11 in Table 2) and transmits the HF-A-MAP IE to the MS in step 415. Although not illustrated in FIG. 4, in step 415 the BS may also transmit the UL A-MAP including information regarding the resources for UL HARQ burst retransmission by the MS. In an exemplary embodiment, the UL A-MAP and HF-A-MAP IE are transmitted in the same subframe.

In an alternative embodiment, if the BS determines in step 407 that a UL resource is not available for UL HARQ burst retransmission such that the UL HARQ retransmission is to be skipped, the BS may proceed to step 415 for transmission of an HF-A-MAP IE corresponding to NACK with UL A-MAP indication to the MS. In that case, the BS also transmits in step 415 a UL A-MAP indicating that the UL HARQ retransmission is to be skipped by the MS.

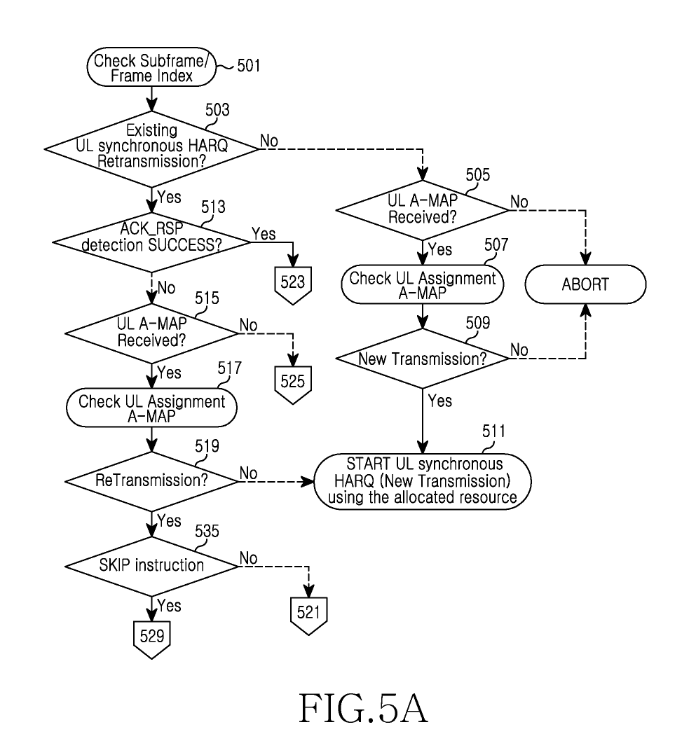

FIG. 5 illustrates a method in an MS for receiving HARQ feedback information according to an exemplary embodiment of the present invention.

Referring to FIG. 5, in step 501, the MS checks the frame index and the subframe index to determine if, in the current subframe/frame, there is any expected HF-A-MAP IE from a corresponding BS as a feedback to the transmitted UL HARQ burst. In step 503, the MS determines from the data of the received frame/subframe if there is an existing synchronous UL HARQ retransmission procedure in progress. If the MS determines that an existing synchronous UL HARQ retransmission procedure is not in progress, the MS proceeds to step 505 and determines if a UL A-MAP is received. If it is determined in step 505 that the UL A-MAP is received, the MS evaluates the UL A-MAP in step 507 to determine what resources are available for a synchronous UL HARQ retransmission procedure. In step 509, the MS determines if a new UL HARQ procedure should begin. If it is determined in step 509 that the new UL HARQ retransmission procedure should begin, the MS starts UL synchronous HARQ using the resources determined in step 507 for a new UL HARQ retransmission procedure in step 511. If it is determined in step 509 that a new UL HARQ procedure should not begin, the MS is made aware of a possible error during the UL HARQ retransmission procedure and aborts without triggering a new UL HARQ retransmission procedure.

Referring again to step 503, if it is determined that an existing synchronous UL HARQ retransmission procedure is in progress, the MS proceeds to step 513 and determines if a DL ACK_RSP (e.g., including an HF-A-MAP IE) message is successfully received and decoded. If the MS determines in step 513 that the DL ACK_RSP message is not properly received and/or decoded, the MS proceeds to step 515 and determines if a UL A-MAP was received. That is, despite not receiving the DL ACK_RSP message, the MS may still proceed with the synchronous UL HARQ procedure if the UL A-MAP is successfully received. If it is determined in step 515 that the UL A-MAP was not received, the MS proceeds to step 525 and stops the synchronous UL HARQ procedure. On the other hand, if it is determined in step 515 that the UL A-MAP was received, the MS proceeds to step 517 and evaluates the received UL A-MAP. The MS then proceeds to step 519 and determines if retransmission of the synchronous HARQ burst is appropriate. For example, if the MS receives the UL A-MAP, it may indicate a change of resources for synchronous UL HARQ burst retransmission, or may indicate that retransmission is to be skipped. Accordingly, in step 535, the MS determines if the UL A-MAP indicates a change of resources for synchronous UL HARQ burst retransmission or an indication that retransmission is to be skipped. If the UL A-MAP indicates a change of resources for the synchronous UL HARQ burst retransmission, the MS proceeds to step 521 and continues the synchronous UL HARQ retransmission using the changed resources identified in the received UL A-MAP. On the other hand, if the UL A-MAP indicates that retransmission is to be skipped, the MS proceeds to step 529 and skips retransmission of the synchronous UL HARQ burst in the current subframe. Referring again to step 519, if the UL A-MAP indicates to trigger a new UL HARQ retransmission procedure, the MS proceeds to step 511 and starts a new UL HARQ retransmission procedure by transmitting a new UL HARQ burst using the allocated resources.

Referring again to step 513, if the MS determines that the DL ACK_RSP message is properly received, the MS proceeds to step 523 where it decodes and evaluates information contained in the HF-A-MAP IE. If the MS determines that the HF-A-MAP IE corresponds to ACK, the MS determines that the BS has successfully received the previous UL HARQ burst and proceeds to step 525 where it stops the synchronous UL HARQ procedure. If the MS determines in step 523 that the HF-A-MAP IE corresponds to NACK, the MS proceeds to step 527 and continues the synchronous UL HARQ retransmission procedure using the previously allocated resources. That is, by receipt of only a NACK, the MS determines that the BS did not properly receive and/or decode the previously transmitted UL HARQ burst and that the resources to be used for retransmission of the UL HARQ burst have not changed. If the MS determines in step 523 that the HF-A-MAP IE corresponds to NACK with retransmission skip indication, the MS proceeds to step 529 and skips retransmission of the UL HARQ burst for the current subframe. Finally, if the MS determines that the HF-A-MAP IE corresponds to NACK with UL A-MAP information indication, the MS proceeds to step 531 and determines if a UL A-MAP has been received. If it is determined in step 531 that the UL A-MAP has been received, the MS proceeds to step 533 and evaluates the UL A-MAP for information regarding a new resource for retransmission of the UL HARQ burst. Upon determining the new resource information, the MS proceeds to step 521 and continues synchronous UL HARQ retransmission using the newly allocated resource. On the other hand, if the MS determines in step 531 that the UL A-MAP was not received, the MS proceeds to step 525 and stops synchronous UL HARQ retransmission. By stopping the UL HARQ retransmission, the MS can avoid potential interference at the BS.

In an alternative embodiment, if the MS determines in step 523 that the HF-A-MAP IE corresponds to NACK with A-MAP information indication, the MS may proceed to step 515 rather than step 531 and follow the subsequent steps. In this case, the MS would further evaluate if retransmission is indicated by the UL A-MAP. That is, the MS would determine if the UL A-MAP indicated that the retransmission of the UL HARQ burst was to be skipped in the current subframe. If retransmission were to be skipped, the MS would proceed to 529 and skip the retransmission for the current subframe.

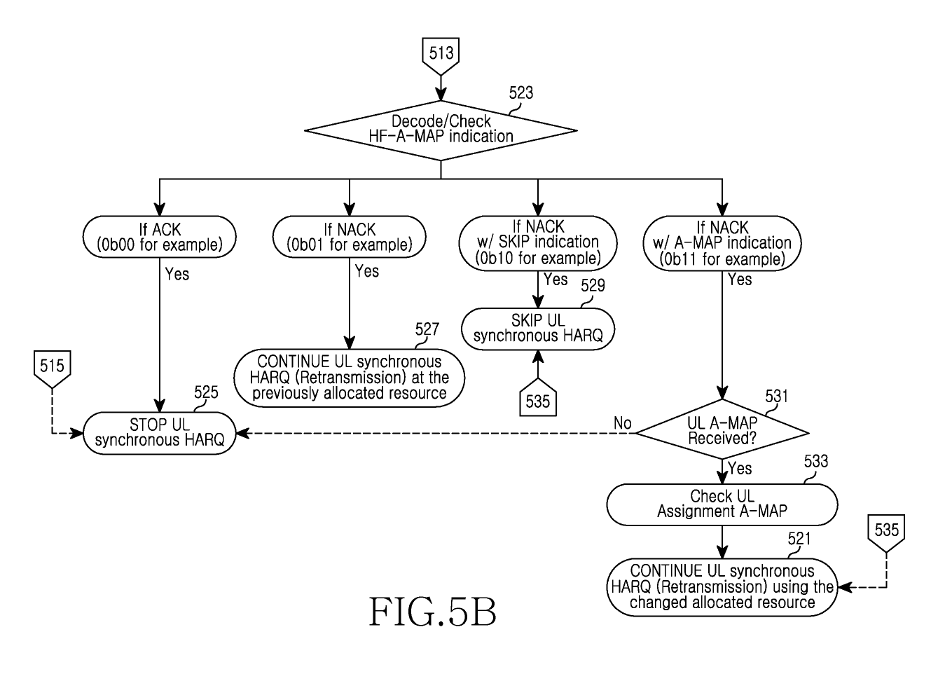

FIG. 6 is a diagram illustrating an internal structure of a BS apparatus according to an exemplary embodiment of the present invention.

Referring to FIG. 6, a BS apparatus 600 includes a controller 610 and a transceiver 620. The controller 610 controls the general operations of the BS including the allocation of resources for a UL HARQ procedure. Among its other functions, the controller 610 determines and allocates resources for a synchronous UL HARQ procedure. The controller 610 also determines if a UL HARQ burst is properly received and decoded. Depending on the receipt of the UL HARQ burst and the determination regarding available resources for a UL HARQ procedure, the controller determines an appropriate ACK_RSP message for feedback to the MS. Exemplary operations in which the controller 610 allocates UL resources and transmits corresponding ACK-RSP messages have been described with reference to FIGS. 3(a), 3(b) and 4 above. The transceiver 620 transmits data from the BS and receives data from an MS including receiving UL HARQ bursts from the MS and transmitting an ACK_RSP message, including an HF-A-MAP IE, to the MS.

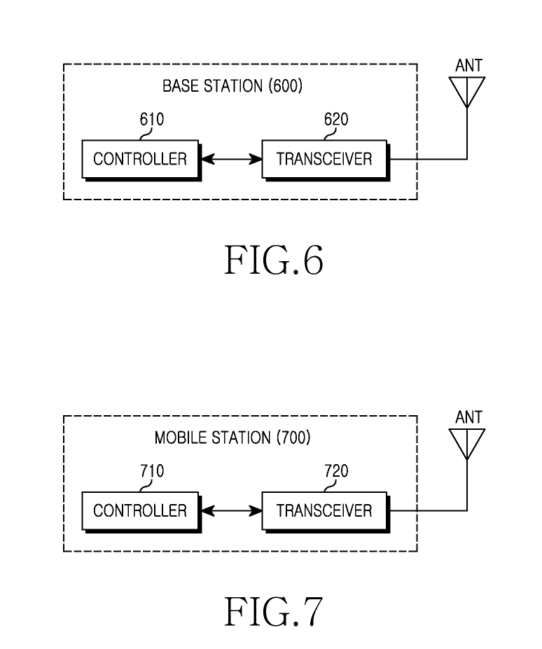

FIG. 7 is a diagram illustrating an internal structure of an MS apparatus according to an exemplary embodiment of the present invention.

Referring to FIG. 7, an MS apparatus 700 includes a controller 710 and a receiver 720. The controller 710 controls the general operations of the MS. In an exemplary implementation, the controller 710 evaluates information received from a BS regarding a UL HARQ retransmission procedure. That is, the controller 710, using feedback information from the BS, determines if the BS has properly received a previously transmitted UL HARQ burst and determines what actions to take based on the feedback from the BS. Exemplary actions taken by the controller 710 based on feedback information from the BS have been described with reference to FIGS. 3(a), 3(b) and 5 above. The transceiver 720 transmits data including the UL HARQ burst to the BS and receives feedback information from the BS. More specifically, the transceiver receives an ACK_RSP message, including an HF-A-MAP IE, from the BS.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method in a Base Station (BS) for feeding back Hybrid Automatic Retransmission reQuest (HARQ) information, the method comprising:
receiving an UpLink (UL) HARQ burst transmitted on a first resource;
determining if the UL HARQ burst has been received correctly;
determining if the first resource for UL HARQ burst transmission needs to be changed; and
transmitting feedback information regarding receipt of the UL HARQ burst and whether the first resource needs to be changed.

2. The method of claim 1, wherein the feedback information comprises four possible outcomes expressed by at least 2 bits,
wherein the four outcomes comprise ACKnowledge (ACK), Negative ACKnowledge (NACK), NACK with retransmission skip indication and NACK with associated UL A-MAP existence indication.

3. The method of claim 1, wherein, if it is determined that the UL HARQ burst has been received correctly, the transmitting of feedback information comprises transmitting first feedback information indicating acknowledging receipt of the UL HARQ burst.

4. The method of claim 1, wherein the determining if the first resource for UL HARQ burst transmission needs to be changed comprises determining if any resource is available for UL HARQ burst transmission.

5. The method of claim 4, wherein, if it is determined that the UL HARQ burst has not been received and that no resource is available for UL HARQ burst transmission, the transmitting of feedback information comprises transmitting second feedback information indicating that the UL HARQ burst was not received and that subsequent retransmission of the UL HARQ burst should be skipped.

6. The method of claim 4, further comprising, if it is determined that the UL HARQ burst has not been received and that a resource is available for UL HARQ burst transmission, determining if the first resource is available for UL HARQ burst transmission.

7. The method of claim 6, wherein, if the first resource is available for UL HARQ burst transmission, the transmitting of feedback information comprises transmitting third feedback information indicating that the UL HARQ burst was not received.

8. The method of claim 6, wherein, if the first resource is not available for UL HARQ burst transmission, the transmitting of feedback information comprises transmitting fourth feedback information indicating that the UL HARQ burst was not received and that a resource for UL HARQ burst transmission has changed.

9. An apparatus in a Base Station for feeding back Hybrid Automatic Retransmission reQuest (HARQ) information, the apparatus comprising:
a controller for determining if the UL HARQ burst has been received correctly, and for determining if the first resource for UL HARQ burst transmission needs to be changed; and
a transceiver for receiving the UL HARQ burst and for transmitting feedback information regarding receipt of the UL HARQ burst and whether the first resource needs to be changed.

10. The apparatus of claim 9, wherein the feedback information comprises four possible outcomes expressed by at least 2 bits,
wherein the four outcomes comprise ACKnowledge (ACK), Negative ACKnowledge (NACK), NACK with retransmission skip indication and NACK with associated UL A-MAP existence indication.

11. The apparatus of claim 9, wherein, if it is determined that the UL HARQ burst has been received, the controller transmits first feedback information indicating acknowledging receipt of the UL HARQ burst.

12. The apparatus of claim 9, wherein the controller determines if the first resource for UL HARQ burst transmission needs to be changed by determining if any resource is available for UL HARQ burst transmission.

13. The apparatus of claim 12, wherein, if it is determined that the UL HARQ burst has not been received and that no resource is available for UL HARQ burst transmission, the controller transmits second feedback information indicating that the UL HARQ burst was not received and that subsequent retransmission of the UL HARQ burst should be skipped.

14. The apparatus of claim 12, wherein, if it is determined that the UL HARQ burst has not been received and that a resource is available for UL HARQ burst transmission, the controller determines if the first resource is available for UL HARQ burst transmission.

15. The apparatus of claim 14, wherein, if the first resource is available for UL HARQ burst transmission, the controller transmits third feedback information indicating that the UL HARQ burst was not received.

16. The apparatus of claim 14, wherein, if the first resource is not available for UL HARQ burst transmission, the controller transmits fourth feedback information indicating that the UL HARQ burst was not received and that a resource for UL HARQ burst transmission has changed.

17. A method in a Mobile Station (MS) for receiving Hybrid Automatic Retransmission reQuest (HARQ) feedback information, the method comprising:
receiving feedback information transmitted;
determining if a previously transmitted UpLink (UL) HARQ burst was received correctly by a receiving apparatus based on the feedback information; and
if the previously transmitted UL HARQ burst was not received by the receiving apparatus, determining if a resource for transmission of the UL HARQ burst has changed based on the feedback information.

18. The method of claim 17, wherein the feedback information comprises four possible outcomes expressed by at least 2 bits,
wherein the four outcomes comprise ACKnowledge (ACK), Negative ACKnowledge (NACK), NACK with retransmission skip indication and NACK with associated UL A-MAP existence indication.

19. The method of claim 17, further comprising, if the previously transmitted UL HARQ burst was not received and the resource for retransmission of the HARQ burst has changed, retransmitting the UL HARQ burst using the changed resource.

20. The method of claim 17, further comprising, if the previously transmitted UL HARQ burst was not received and the resource for retransmission of the HARQ burst has not changed, retransmitting the UL HARQ burst using the resource.

21. The method of claim 17, further comprising, if the feedback information has not been received:
determining if the resource for retransmission of the UL HARQ burst has changed;
if the resource for retransmission of the UL HARQ burst has changed, retransmitting the UL HARQ burst using the changed resource.

22. An apparatus in a Mobile Station (MS) for receiving Hybrid Automatic Retransmission reQuest (HARQ) feedback information, the apparatus comprising:
a transceiver for receiving feedback information; and
a controller for determining if the feedback information has been received, for, if the feedback information has been received, determining if a previously transmitted UpLink (UL) HARQ burst was received by a receiving apparatus based on the feedback information, and for, if the previously transmitted UL HARQ burst was not received by the receiving apparatus, determining if a resource for transmission of the UL HARQ burst has changed based on the feedback information.

23. The apparatus of claim 22, wherein the feedback information comprises four possible outcomes expressed by at least 2 bits.

24. The apparatus of claim 23, wherein the controller, if the previously transmitted UL HARQ burst was not received and the resource for retransmission of the HARQ burst has changed, retransmits the UL HARQ burst using the changed resource.

25. The apparatus of claim 23, wherein the controller, if the previously transmitted UL HARQ burst was not received and the resource for retransmission of the HARQ burst has not changed, retransmits the UL HARQ burst using the resource.

26. The apparatus of claim 22, wherein the controller, if the feedback information has not been received, determines if the resource for retransmission of the UL HARQ burst has changed, and, if the resource for retransmission of the UL HARQ burst has changed, retransmits the UL HARQ burst using the changed resource.
